(19) United States
(12) Patent Application Publication
(10) Pub. No.: US 2010/0016769 A1
(43) Pub. Date: Jan. 21, 2010

(54) Vibrator Device

(75) Inventors: Dieter Rach, Hohen Neuendorf (DE); Reimund Meier, Hohen Neuendorf (DE); Steffen Finsterbusch, Mulsen (DE)

Correspondence Address: THE WEBB LAW FIRM, P.C., 700 KOPPERS BUILDING, 436 SEVENTH AVENUE, PITTSBURGH, PA, 15219, US

(73) Assignee: UNIPHY ELEKTROMEDIZIN GMBH & CO., KG, Henningsdorf (DE)

(21) Appl. No.: 12/508,055

(22) Filed: Jul. 23, 2009

(30) Foreign Application Priority Data
Jun. 27, 2007 (DE) 10 2007 030 582.8
Jun. 23, 2008 (EP) 08 158742.0

(51) Int. Cl. A61H 1/00

(52) U.S. Cl. 601/46

(57) ABSTRACT

The invention relates to a vibrator device for introducing vibrations into a person, comprising a carrier that is adapted and provided to contact a person for introducing vibrations into said person, a vibration generator that is adapted and provided to perform a vibration, wherein the vibration generator is pivotably supported about a pivoting axis on the carrier in order to transfer vibrations to the carrier. According to the invention, the vibration generator is elastically supported on the carrier in a plane extending perpendicular to the pivoting axis.

### FIELD OF THE INVENTION

The invention relates to a vibrator device.

### BACKGROUND OF THE INVENTION

Such a vibrator device for introducing vibrations into a person comprises a carrier that is adapted an provided to contact a person for introducing vibrations into said person, a vibration generator that is adapted and provided to perform a vibration, wherein the vibration generator is pivotably supported about a pivoting axis on the carrier for transferring vibrations to the carrier.

The problem underlying the invention is to provide a vibrator device of the afore-mentioned kind, which is improved concerning the support of the vibration generator

### SUMMARY OF THE INVENTION

This problem is solved by a vibrator device for introducing vibrations into a person, comprising: a carrier which is adapted and provided for contacting a person in order to introduce vibrations into said person, a vibration generator that is adapted and provided to perform a vibration, wherein the vibration generator is pivotably supported on the carrier about a pivoting axis in order to transfer vibrations to the carrier.

According to the invention, it is further provided that the vibration generator is pivotably elastically supported on the carrier in a plane extending perpendicular to the pivoting axis, namely in particular without a ball bearing. I.e., the pivoting axis can be displaced by a pre-definable amount along all directions contained in said plane, wherein, due to the elastic support, the pivoting axis returns into its initial position. According to an aspect of the invention, the vibration generator is elastically supported at two points of the pivoting axis being spaced apart with respect to each other along the pivoting axis, so that the pivoting axis can also change its angular position in space, i.e., the pivoting axis can be rotated out of its initial position by a pre-definable amount, wherein also in this case a retraction into the initial position takes place due to the elastic support.

By means of the pivotable support of the vibration generator it is assured that essentially only those vibrations of the vibration generator are transferred to the carrier that take place along the gravitational force of the vibration generator (across the pivoting axis). I.e., in case of a carrier extending along a horizontal plane, such a coupling between the vibration generator and the carrier causes a periodical movement of the carrier between two reversal points facing each other along the vertical.

According to an aspect of the invention, the vibration generator is also elastically supported on the carrier along the pivoting axis, i.e., the vibration generator can be displaced by a pre-definable amount along the pivoting axis, wherein also in this case the elastic support causes a retraction of the vibration generator into its initial position (force-free position).

The vibrator device according to the invention therefore comprises a low-wear and low noise bearing.

At least one bearing element is provided for the afore-mentioned elastic support of the vibration generator, wherein said at least one bearing element in case of a vibration generator being pivoted about the pivoting axis in a pivoting direction (circulating the pivoting axis) causes a restoring pivoting movement of the vibration generator in the opposite pivoting direction.

Such a pivoting movement being part of a pendulum motion of the vibration generator is caused due to the fact that the vibration generator for generating vibrations preferably comprises unbalances rotating about a rotation axis which cause a circular vibration of the vibration generator in a plane extending perpendicular to the pivoting axis. Those fractions of said circular vibration that are oriented along the vertical are transferred onto the carrier, whereas those vibrations that are oriented across thereto (along the horizontal) are decisively responsible for the pendulum movement of the vibration generator along the horizontal. Of course, the carrier can also be forced to perform horizontal vibrations due to the pivotable support of the vibration generator on the carrier, so that the carrier finally performs a vibration having an elliptical path in a plane perpendicular to the rotation or pivoting axis whose principle axis is oriented along the vertical and is significantly larger than the minor axis of said elliptical path running along the horizontal. Ideally the support is designed such that the minor axis vanishes and a linear vibration path extending along the vertical results.

According to an aspect of the invention, the at least one bearing element comprises an elastically deformable body for the elastic support of the vibration generator, which elastic body preferably encompasses the pivoting axis in a plane extending perpendicular to the pivoting axis. In an embodiment of the invention, said body of the bearing element consists of a rubber.

In an embodiment of the invention the elastically deformable body is formed as a hollow cylinder, wherein said hollow cylinder is enclosed by a first bushing (preferably hollow cylindrical) encompassing the pivoting axis in a form-fit and substance-to-substance manner, wherein the cylinder axes of the body and the first bushing coincide, Particularly, the first bushing is firmly connected to the outer lateral area of the elastic body facing outwards. Furthermore, the at least one bearing element is firmly connected to the carrier via the first bushing.

The inner lateral area of the elastic body facing inwards is preferably connected in a form-fit and substance-to-substance manner to a second bushing circulating the pivoting axis. I.e., the cross-section of the second bushing is encompassed by the elastic body as well as by the first bushing. Since both of the bushings are connected to each other via the elastic body, they can be rotated against each other or the cylinder axes of the bushings can be brought out of alignment, and they can be displaced against each other along their cylinder axes, wherein the elastic body causes retraction of the bushings, respectively, so that the cylinder axes of the bushings coincide, and the bushings are no longer displaced against each other along the common cylinder axis. According to an aspect of the invention, the cylinder axes of the bushings and the elastic body coincide with the pivoting axis of the vibration generator.

According to an aspect of the invention, the bearing element is firmly connected to the vibration generator via the second bushing. For this, a bolt is particularly form-fittedly inserted into the second bushing, so that the bolt reaches through the second bushing, wherein a free end portion of the bolt protrudes out of the second bushing, and is connected with a flange protruding from the vibration generator, particularly screwed together with the flange. For this, said free end portion of the bolt comprises a corresponding thread. In particular, the bolt is inserted into the second bushing such that it coincides with the pivoting axis.

For securing the first bushing to the carrier, a reception for the first bushing is preferably provided on the carrier, which reception firmly encompasses the first bushing in a plane extending perpendicular to the pivoting axis in order to secure the at least one bearing element to the carrier, so that, in particular, the first bushing is fixedly held by the reception. Such a reception may also be formed on a separate carrier plate of the carrier of sheetlike nature, i.e., the carrier can consist of several parts.

According to an aspect of the invention, a further bearing element is provided for elastic support of the vibration generator, wherein the further bearing element faces the other bearing element along the pivoting axis. Concerning the design of the further bearing element the things said above hold correspondingly.

The elastic properties of the bodies of the bearing elements are essentially determined by the geometric dimensions of said bodies as well as by the elastic properties of the materials out of which the elastically deformable bodies are produced (in case of elastic bodies out of an elastomer the elastic properties are essentially characterized by the Shore hardness of the elastomer).

Notably according to an aspect of the invention, the vibration generator is adapted and provided to perform a vibration in form of a circular vibration, wherein the vibration generator is preferably pivotably supported on the carrier in a way, that the carrier is only forced to perform vertical vibrations and horizontal vibrations are suppressed as far as possible.

The carrier of the vibrator device serves for receiving a person into which the vibrations generated by the vibration generator and transferred onto the carrier are to be introduced, so that the body of said person is forced to perform a corresponding oscillation (vibration). For receiving the person, the carrier forms a surface which, in case of a carrier that is arranged as intended, extends in a horizontal plane, so that a person can stand or sit on said surface, or can occupy said surface in another manner. Said vertical vibrations the carrier is forced to perform therefore run perpendicular to said surface of the carrier. The carrier can thereby take up the complete weight of said person.

According to an aspect of the invention, the pivoting axis about which the vibration generator is pivotably supported on the carrier, extends—with respect to the vertical—below said surface, namely in particular parallel to said surface of the carrier. Thereby, the vibration generator is hangingly arranged on the carrier and below the carrier along the vertical, so that the weight of the vibration generator is introduced via all bearing elements into the carrier.

The carrier itself is coupled via at least one spring element to a bottom plate arranged below the carrier and extending parallel to the carrier, which bottom plate is adapted and provided to be arranged onto a planar basis extending along a horizontal plane (e.g. a floor). For this, stands protrude from the bottom plate towards the basis, via which stands the bottom plate is supported on the basis. In order to avoid the transfer of vibrations onto the basis, the stands are formed elastically deformable for damping of the vibrations. According to an aspect of the invention, the stands consist of a rubber. The damping characteristics of the so natured support of the bottom plate are determined by the number of stands, the shape of the stands as well as eventually by the properties of the rubber used for the stands (Shore hardness).

According to an aspect of the invention, the at least one spring element is supported on a supporting element (socket) of the bottom plate, which supporting element extends perpendicular to the bottom plate and protrudes from the bottom plate towards the carrier, and which supporting element aligns with the spring element. The length of the supporting element along its extension direction is dimensioned such that the vibration generator does not contact the bottom plate even in case of full compression of the at least one spring element along the extension direction (the vertical). According to an aspect of the invention, the bottom plate comprises below the vibration generator a continuous recess (opening). This opening serves on one hand as a mounting opening, through which the vibration generator of the vibrator device can be removed or mounted, wherein this opening additionally provides for an increased distance between the vibration generator and the bottom plate or a basis running below the bottom plate. In case of the existence of such an opening, the vibration generator is therefore able to vibrate beyond the extension plane of the bottom plate.

According to an aspect of the invention, the carrier is coupled to the bottom plate via a plurality of spring elements of the afore-mentioned kind. According to an aspect of the invention, the spring elements are hollow rubber springs having a bellows-like shape.

According to an aspect of the invention, the vibration generator is adapted to perform a vibration in the form of a circular movement in a plane extending perpendicular to the pivoting axis. The support being pivotable about a pivoting axis now assures that primarily the fraction of said vibration of the vibration generator is transferred onto the carrier which is oriented perpendicular with respect to the carrier. The fractions oriented across thereto cause a pendulum movement of the pivotably suspended vibration generator, so that the tendency of the carrier to perform a vibration along its extension direction is comparatively low.

For generating the vibration, the vibration generator comprises a shaft rotatable about a rotation axis on which at least one mass element is arranged which center of mass is spaced apart from the rotation axis across the rotation axis. According to an aspect of the invention, the rotation axis runs parallel to the pivoting axis, namely preferably below the pivoting axis. Upon rotation of the shaft, the center of mass of the vibration generator performs a circular vibration due to this unbalance in a plane extending perpendicular to said rotation axis. According to an aspect of the invention, a further mass element of the afore-mentioned kind is arranged on the shaft, wherein both of the mass elements are preferably arranged on a free end section of the shaft, respectively, and face each other along the shaft.

According to an aspect of the invention, the mass elements can be manipulated in a way that arbitrary unbalances of the shaft can be created. This can be realized for instance by means of mass elements comprising each at least two parts being displaceable (rotatable) against each other, which parts can be displaced against each other (rotated against each other about the shaft) such that the center of mass of the mass element consisting of the two parts can be displaced towards the shaft or away from the shaft across the shaft.

Thereby, said parts of the mass elements being displaceable or rotatable against each other are preferably supported on the shaft in a way that a displacement or rotation of both of the parts of a mass element against each other that displaces the center of mass of the unbalance is triggered by means of a reversion of rotation of the shaft. In this way the amplitude of the vibration to be generated can be varied at least between two values (corresponding to different unbalances of the shaft) by means of a reversion of rotation. The frequency of the vibration to be generated is decisively determined by the rotation frequency of the shaft.

The parts of a mass element (unbalance) preferably comprise stops that limit the rotation (displacement) of said parts against each other.

### BRIEF DESCRIPTION OF THE DRAWINGS

The described features and advantages of the invention shall be pointed up by means of the following description of embodiments with reference to the figures. It is shown in

FIG. 1 a plan view onto a vibrator device according to the invention;

FIG. 2 a partially cross-sectional view of the vibrator device shown FIG. 1 along the line II-II of FIG. 1;

FIG. 3 a detail of FIG. 2;

FIG. 4 a side view of the vibrator device shown in FIGS. 1 to 3;

FIG. 5 a partially cross-sectional view of the vibrator device shown in FIGS. 1 to 4 along the line V-V of FIG. 4;

FIG. 6 a detail of FIG. 5;

FIG. 7 a side view of a vibration generator of a vibrator device according to the invention;

FIG. 8 a further side view of the vibration generator shown in FIG. 7;

FIG. 9 a partially cross-sectional view of the vibration generator shown in FIGS. 7 and 8 along the line IX-IX of FIG. 8;

FIG. 10 a partially cross-sectional, perspective view of the vibration generator shown in FIGS. 7 to 9 along the line IX-IX of FIG. 8;

FIG. 11 a further partially cross-sectional and perspective view of the vibration generator shown in FIGS. 7 to 10 along the line IX-IX of FIG. 8;

FIG. 12 a perspective view of the vibration generator shown in FIGS. 7 to 11;

FIG. 13 a perspective, exploded view of a carrier plate of a carrier of a vibrator device according to the invention, wherein the vibration generator is to be secured via said carrier plate to the carrier of the vibrator device;

FIG. 14 a perspective view of the carrier plate shown in FIG. 13;

FIG. 15 a perspective view of a lower side of a carrier of a vibrator device according to the invention without the carrier plate shown in FIGS. 13 to 14;

FIG. 16 a perspective view of the lower side of the carrier shown in FIG. 15, with a carrier plate mounted thereto on which a vibration generator of the kind shown in FIGS. 7 to 12 is pivotably supported;

FIG. 17 a section-like, perspective view of the lower side of a vibration device according to the invention;

FIG. 18 a side view of a vibrator device according to the invention having an additional activation device in the form of a hand switch;

FIG. 19 a further side view of the vibrator device shown in FIG. 18; and

FIG. 20 a perspective view of the lower side of the vibrator device shown in FIGS. 18 and 19.

### DETAILED DESCRIPTION OF THE PREFERRED EMBODIMENTS

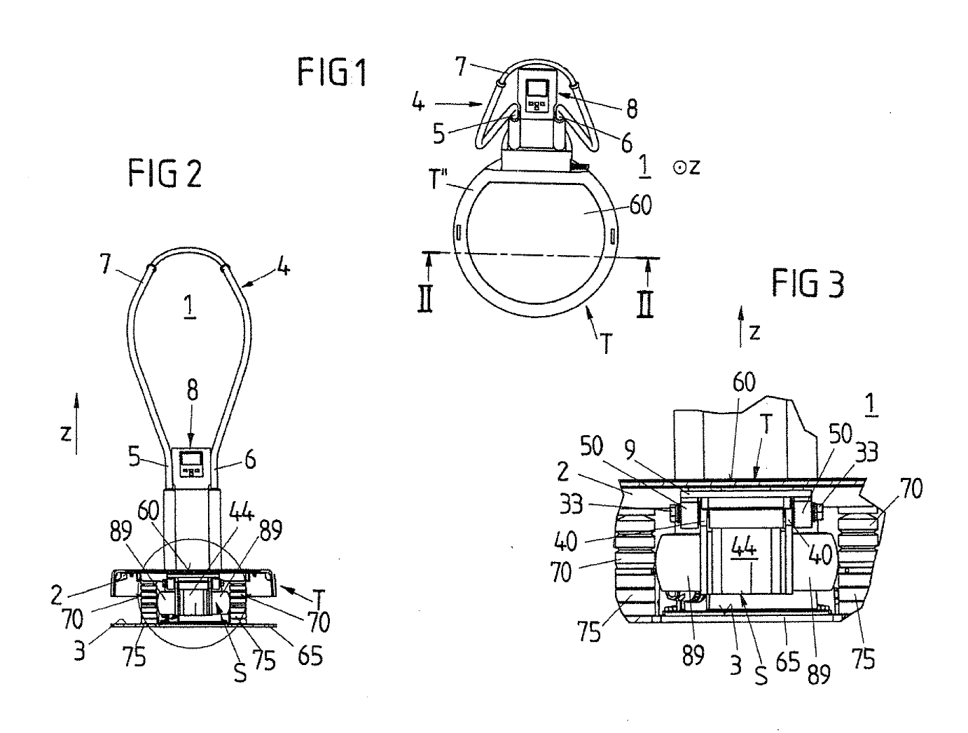

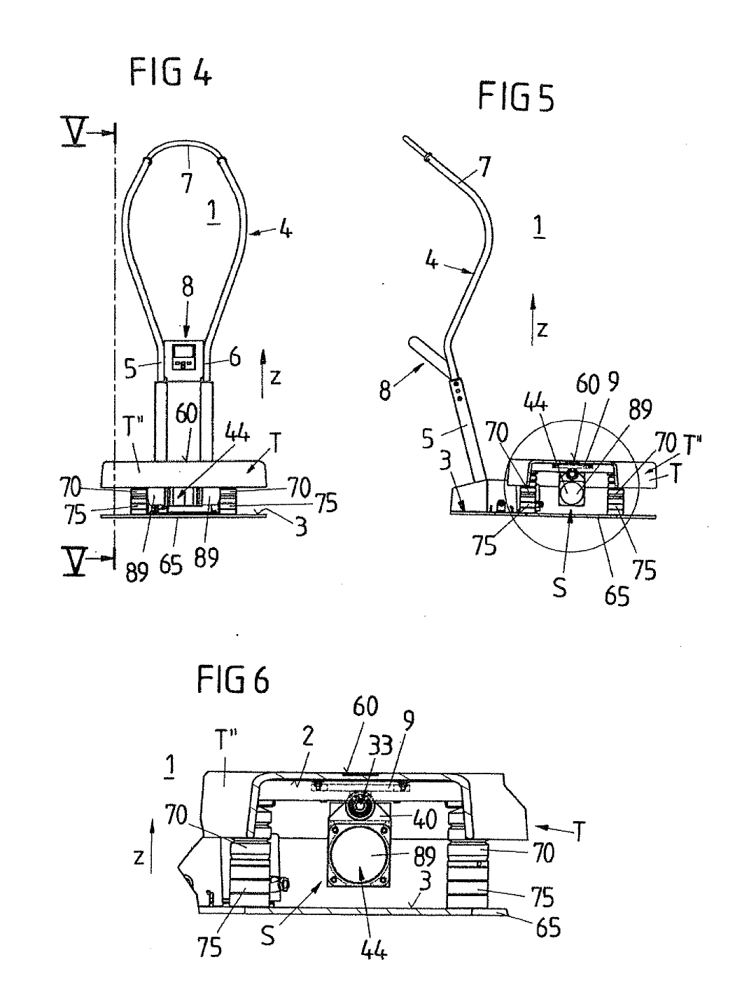

FIG. 1 shows in conjunction with FIGS. 2 to 6 and 17 a vibrator device 1 according to the invention having a carrier T which is supported via four spring elements 70 on a bottom plate 65 arranged below the carrier T along the vertical (in the following z-axis). On a lower side 2 facing the bottom plate 65 a vibration generator S is pivotably supported on the carrier T.

The carrier T forms a surface 60 which extends—with respect to a vibrator device 1 that is positioned as intended—along the x-y-plane extending perpendicular to the z-axis, along which x-y-plane also the bottom plate 65 extends that is arranged below the carrier T or the surface 60, respectively, which bottom plate 65 is designed to be arranged onto a planar basis (running along the x-y-plane), so that the vibrator device 1 has a stable stand. The surface 60 is designed to be occupied by a person. For this, said person can stand or sit on said surface 60 of the carrier T, or may occupy it in another manner. The carrier T can thereby take up the complete weight of the person.

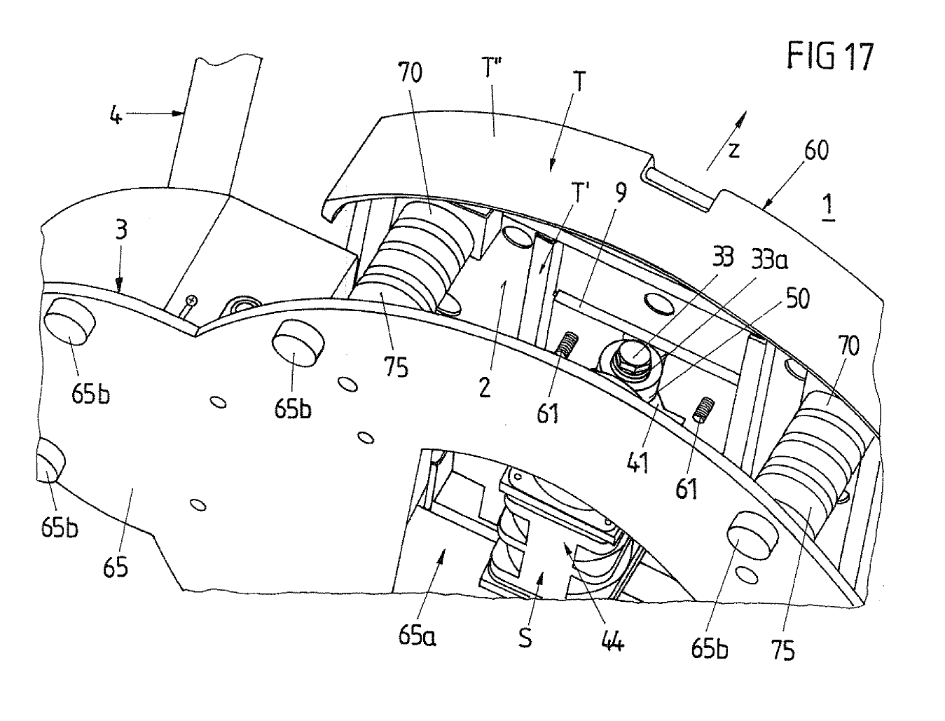

According to an aspect of the invention, the carrier T comprises a frame T′ for stiffening (cf. particularly FIGS. 15 and 17) which preferably consists of a metal, wherein the vibration generator S is preferably connected to the carrier T via said frame T′. A cap T″ forming the surface 60 is secured to this frame, which cap T″ is preferably designed out of a fiber composite. The fibers can be glass fibers or carbon fibers, for instance. The cap T″ can be produced by laminating fibers (particularly fiber mats) or by injection molding.

On the lower side 2 of the carrier T the spring elements 70 protrude from corresponding fastening regions 71 (cf. FIG. 15) of the Frame T′ of the carrier T towards the bottom plate 65 along an extension direction running parallel to the z-axis and are each supported on a respective supporting element 75, wherein the supporting elements 75 protrude from the bottom plate 65 towards the carrier T along an extension direction being oriented parallel to the z-axis. Thereby, the supporting elements 75 are aligned with the corresponding spring elements 70, respectively. According to the FIGS. 17 and 20 the bottom plate 65 comprises a central continuous opening 65a through which the vibration generator S can be secured to the frame T′ of the carrier T or can be removed from the carrier T. Furthermore, this opening 65a provides a sufficient free space for the vibration generator S downwards. For a secure stand and for damping of the vibrations generated by the vibration generator S, the bottom plate comprises stands 65b out of a rubber via which the bottom plate 65 can rest onto a planar basis.

A handhold 4 protrudes along the z-axis from an upper side 3 of the bottom plate 65 facing the lower side 2, which handhold 4 can be comfortably held by a person occupying the surface 60, particularly a person standing on this surface 60. The handhold 4 comprises two end sections 5, 6 running parallel with respect to each other via which said handhold 4 is secured to the bottom plate 65, wherein both of the two end sections 5, 6 are connected two each other via a bent middle section 7. A control unit 8 is provided at the handhold 4 by means of which the vibration generator 4 is operable. This means in particular to activate, deactivate and to set (program) the vibration generator S. Furthermore, the control unit 8 can store (eventually programmable) settings of the vibration generator S by means of a storage means, in particular the variation of the frequency and amplitude in time of a vibration generated by the vibration generator S, the period of the vibration, exercise courses, as well as system settings (e.g. language of the program guide). In a modification of the invention, the storage means can be designed as a portable storage means (chip card).

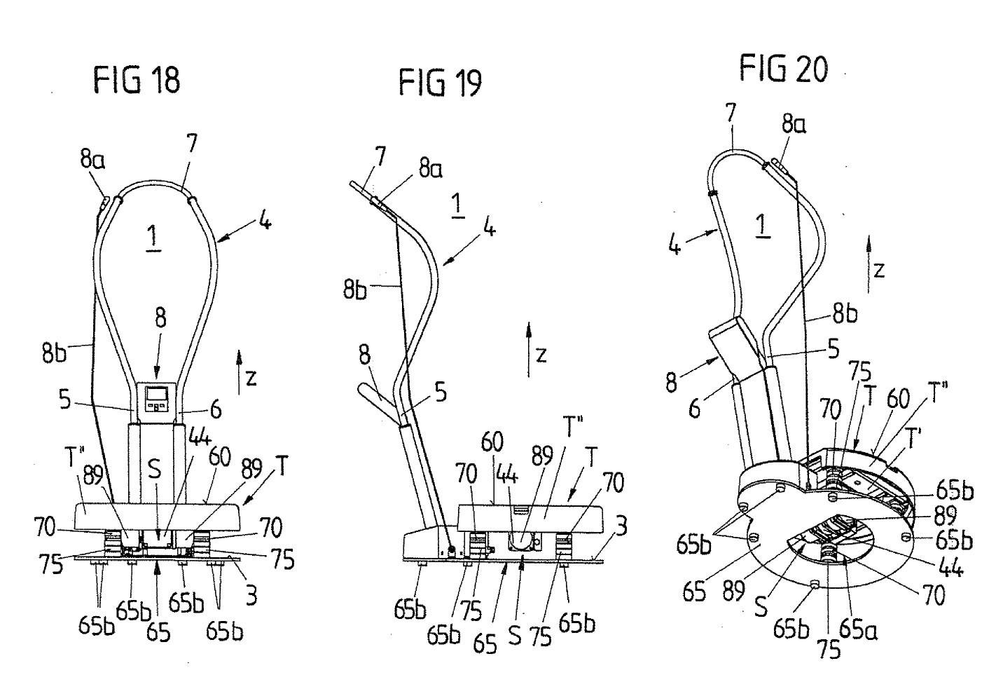

In order to be able to operate the vibrator device 1 in case a person cannot reach due to its current position in space the control unit 8, the vibrator device 1 comprises according to FIGS. 18 to 20 a portable operating unit 8a in the form of a hand switch by means of which the vibrator device 1 can be particularly switched on and off. This hand switch 8a can be connected to the vibrator device 1 by means of a flexible cable connection or wirelessly. The hand switch 8a can be attached to the hand hold 4 on demand.

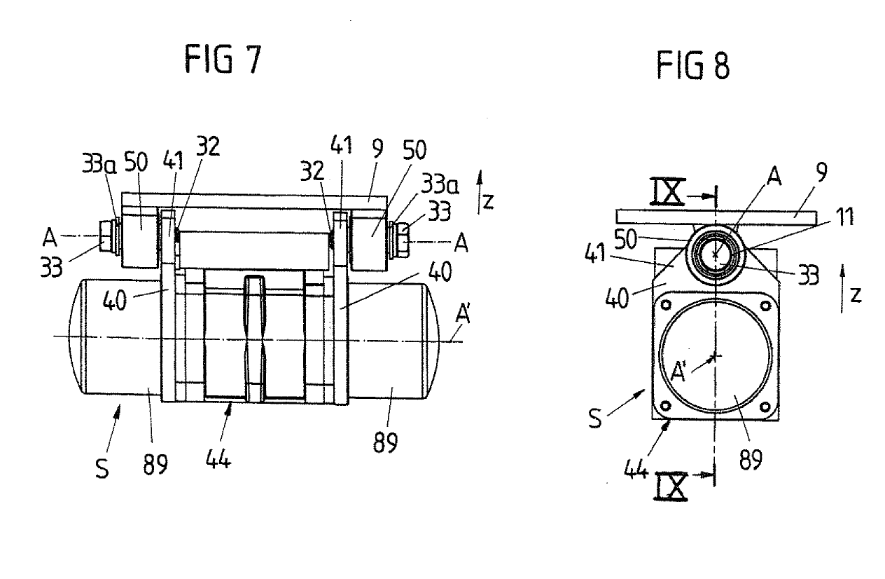

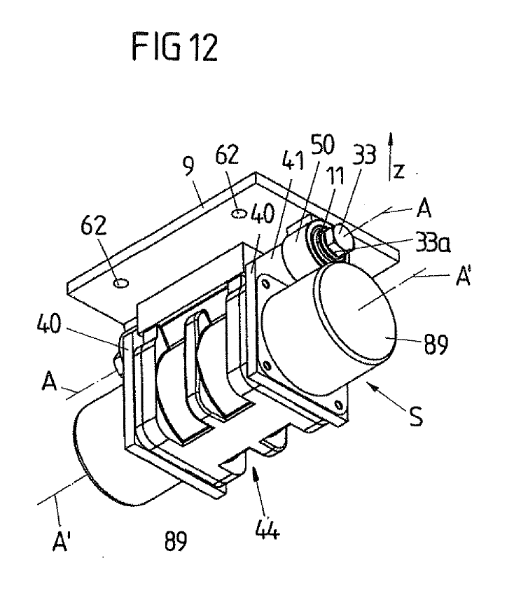

FIG. 7 shows in conjunction with the FIGS. 8 to 12 the vibration generator S. This vibration generator S is adapted and provided for performing a circular vibration movement which can be transferred via the support on the carrier T onto said carrier T so that the vibrating carrier T can force a person occupying the surface 60 of the carrier T to vibrate correspondingly. Here, particularly the whole body of the person can be forced to vibrate. The vibrator device 1 is particularly suitable for physiotherapeutic therapy and for sportive training of a person.

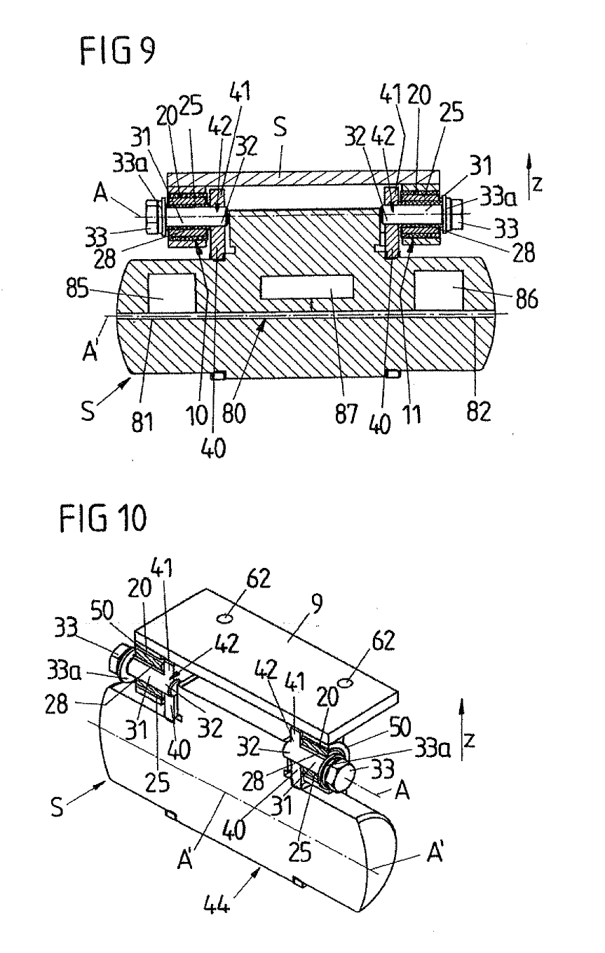

For generating the circular vibration, the vibration generator S comprises a motor 87, particularly an electric motor, driving a shaft 80 extending along a rotation axis A′, so that the shaft 80 rotates about the rotation axis A′. A mass element is provided on two opposing end sections 81, 82 of the shaft 80, respectively, whose center of mass does not coincide with the rotation axis A′. These mass elements 85, 86 therefore represent an unbalance that forces a circular movement (vibration) of the vibration generator S in a plane perpendicular to the shaft 80. The motor 87, the shaft 80 and the mass elements 85, 86 are schematically characterized in FIG. 9.

In order to transform this circular vibration movement into a linear vibration of the carrier T along the z-axis, so that particularly the surface 60 merely vibrates along the z-axis, the vibration generator S is pivotably supported (suspended) about a pivoting axis A on the lower side 2 of the carrier T facing the bottom plate 65.

The pivoting axis A thereby runs parallel to the surface 60 of the carrier T, i.e., parallel to the x-y-plane, wherein the rotation axis A′ of the vibration generator S is spaced apart from the pivoting axis A along the z-axis and is arranged parallel to the pivoting axis A. Thereby, the pivoting axis A lies in particular congruentially above the rotation axis A′.

Due to this pivotable support, primarily the vibration component of the circular vibration of the vibration generator S running along the z-axis is effectively transferred onto the carrier T. The component of said vibration being oriented perpendicular to the z-axis causes a pendulum movement of the vibration generator S about the pivoting axis A, whose influence on the vibration of the carrier T decreases with increasing distance between the pivoting axis A and the rotation axis A′ along the z-axis, i.e., the unwanted horizontal vibrations of the carrier T across the z-axis decrease with increasing distance between the pivoting axis A and the rotation axis A′.

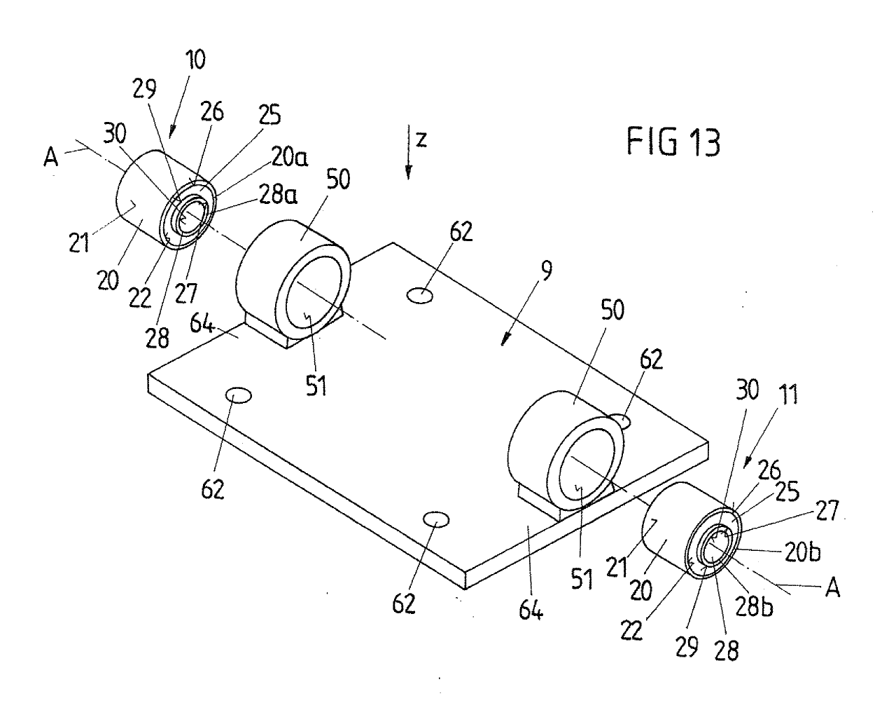

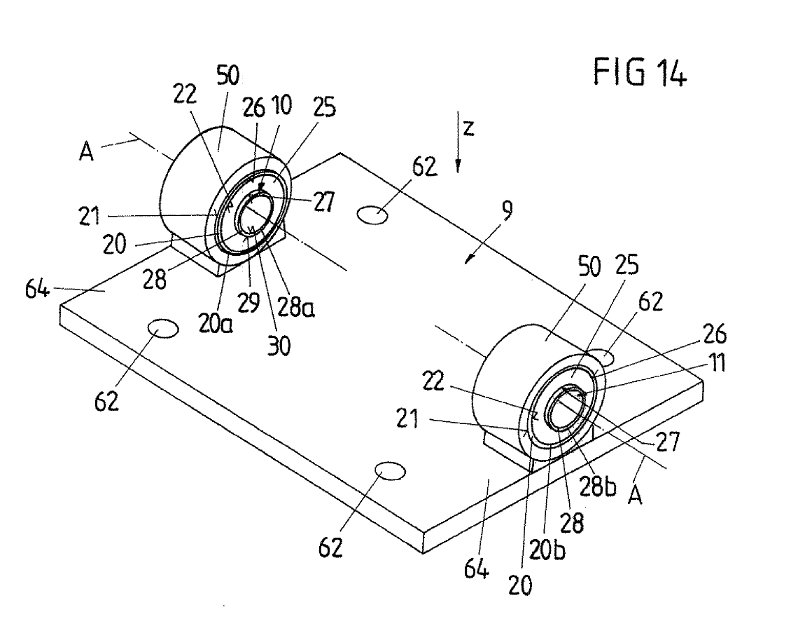

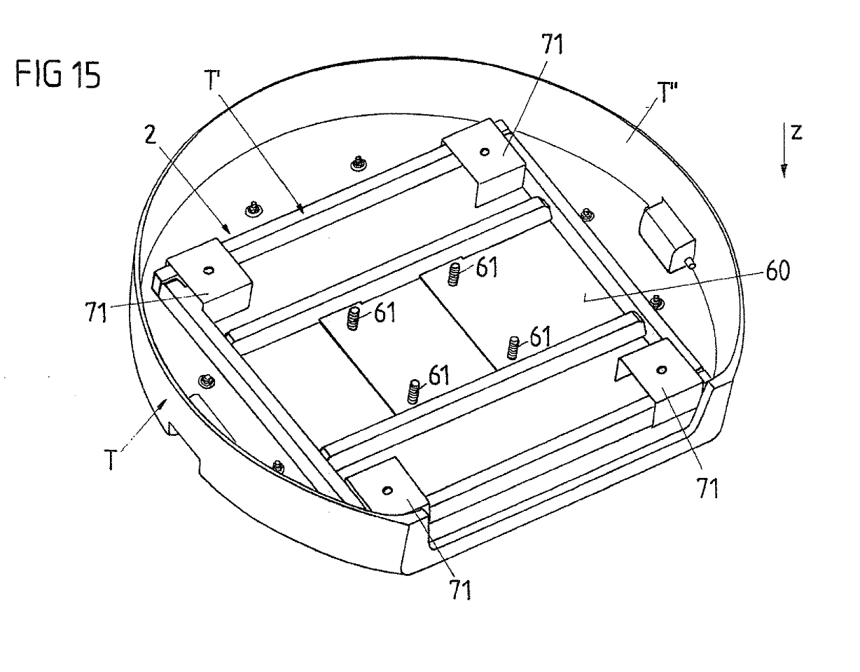

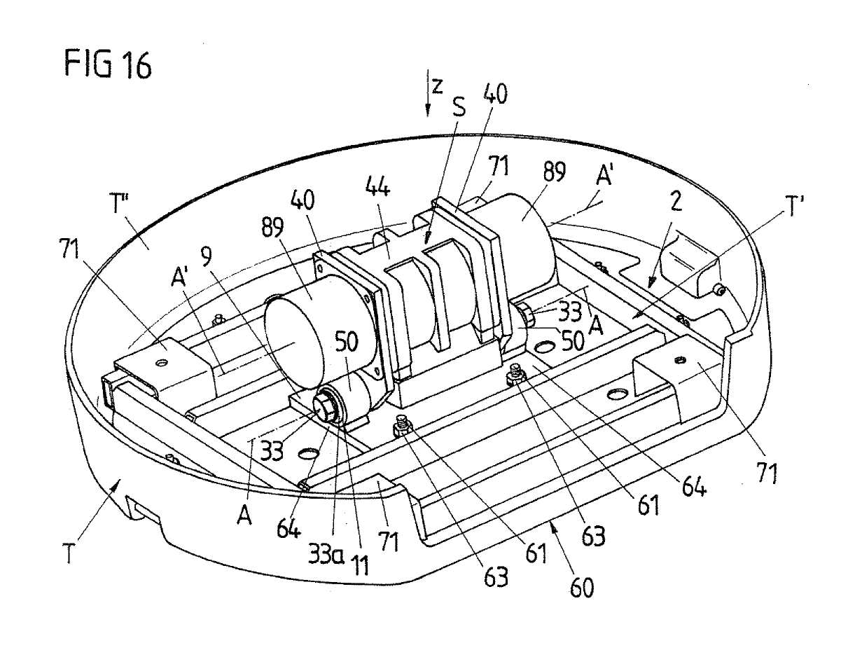

In order to support the vibration generator S in the afore-mentioned manner on the lower side 2 of the carrier T, a two-dimensional, particularly rectangular carrier plate 9 is provided according to FIGS. 13 and 14, which according to FIGS. 15 and 16 is secured to the middle of the lower side 2 of the carrier T below said surface 60 of the carrier T, namely preferably to the frame T′ of the carrier T.

For this, two bolts 61 protrude from the lower side 2 of the carrier T (particularly of the frame T′), which bolts 61 reach through corresponding through openings 62 of the carrier plate 9. The bolts 61 comprise an external thread, respectively, so that free end portions of said bolts 61 can be screwed together with suitable nuts 63 which press the carrier plate 9 against the lower side 2 of the carrier T. The carrier plate 9 may also be designed as an area of the carrier T that is integrally formed with the carrier T (particularly with the frame T′).

From two boundary areas 64 of the carrier plate 9 facing each other along the pivoting axis A two hollow cylindrical receptions 50 protrude along the z-axis towards the bottom plate 65, whose cylinder axes coincide with the pivoting axis A, respectively. These receptions 50 are designed to receive a bearing element 10, 11, respectively, for elastic support of the vibration generator S on the carrier T.

Both of the bearing elements 10, 11 thereby comprise an outer first bushing 20 which is formed hollow cylindrical and correspondingly comprises an outer lateral area 21 facing outwards, and an inner lateral area 22 facing away from the outer lateral area 21, wherein the cylinder axis of the first bushing 20 is aligned with the pivoting axis A.

Both of the bearing elements 10, 11 are firmly connected via the outer lateral areas 21 to an inner surface 51 of the respective reception 50 facing the outer lateral area 21, respectively. For this, both of the bearing elements 10, 11 are inserted into the receptions 50 along the pivoting axis A.

In order to have a support mediated by the bearing elements 10, 11 that is of elastic nature and that allows for a displacement of the pivoting axis A across the pivoting axis A as well as along the pivoting axis A as well as further for a deflection of the pivoting axis A, each bearing element 10, 11 comprises an elastically deformable body 25 out of a rubber, which is formed as a hollow cylinder.

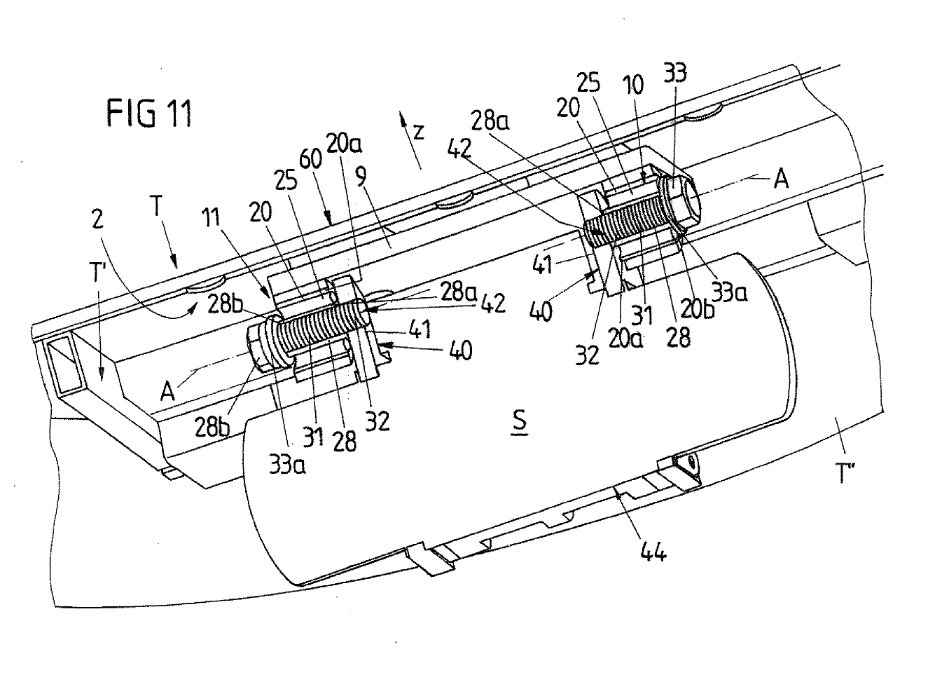

The bodies 25 each comprise an outer lateral area 26 facing outwards as well as an inner lateral area 27 facing inwards (facing away from the outer lateral area 26), wherein said bodies 25 are respectively connected via their outer lateral areas 26 with the inner lateral areas 22 of the first bushings 20 in a form-fit and substance-to-substance manner. Via their inner lateral areas 27, the elastically deformable bodies 25 are respectively firmly connected to an outer lateral area 29 of a second hollow cylindrical bushing 28 of the respective bearing element 10, 11 which are coaxially arranged with respect to the first bushing 20, respectively, so that the cylinder axes of the second bushings 28 are also aligned with the pivoting axis A. Furthermore, the second bushing 28 comprises an inner lateral area 30 which faces away from the outer lateral area 29 of the second bushing 28. The inner lateral areas 30 of the second bushings 28 each define a recess of the second bushings 28, into which a bolt 31 (cf. in particular FIGS. 9 and 11) is insertable, respectively, for securing the vibration generator S. Along the pivoting axis A, both of the lateral areas 21, 22 of the first bushing 20 and both of the lateral areas 29, 30 of the second bushings 28 are limited by two front faces 20a, 20b or 28a, 28b, which face each other along the pivoting axis A (or along the cylinder axis of the respective bushing 20, 28).

In this way, the outer first bushing 20 is elastically coupled via the elastically deformable body 25 to the second bushing 28 arranged inside of the first bushing 20. The elastic body 25 thereby fills up the interspace between the coaxially arranged bushings 20, 28, i.e., the elastic body 25 is arranged across the pivoting axis A between the inner lateral area 22 of the first bushing 20 and the outer lateral area 29 of the second bushing 28. Both of the bushings 20, 28 of the bearing elements 10, 11 are preferably manufactured out of a metal.

Via said second bushings 28 the vibration generator S is now connected to the bearing elements 10, 11 (cf. in particular FIGS. 9 and 11). For this, two flanges 40 protrude from the vibration generator S particularly perpendicular to its rotation axis A′, which flanges 40 are spaced apart along the rotation axis A′ and comprise at a free end portion 41 a recess 42 having an internal thread, respectively. According to an aspect of the invention, said flanges 40 are connected to a housing 44 of the vibration generator S which forms a reception for the motor 87, the shaft 80, and the mass elements 85, 86. According to an aspect of the invention, the mass elements 85, 86 are covered by cap-shaped elements 89 of the housing 44, respectively.

For securing the vibration generator S to both of the bearing elements 10, 11 a bolt aligning with the pivoting axis A is inserted along the pivoting axis A into the second bushing 28, respectively, that reaches through the respective second bushing 28 with a free end portion 32, wherein said free end portions 32 are screwed into a recess 42, respectively, so that the heads 33 of the bolts 31 press against the front faces 28b of the second bushings 28 on the sides of the bushings 28 facing away from the flanges 40 (eventually via washers 33a), whereby the second bushings 28 are firmly pressed against the flanges 40 with the respectively opposing front faces 28a (for this, the front faces 28a, 28b of the second bushings 28 preferably protrude along the cylinder axis of the second bushings 28 beyond the front faces 20a, 20b of the first bushings 20). According to an aspect of the invention, the bolts 31 comprise no play in the second bushings 28, i.e., the second bushings 28 firmly encompass the cross-section of the bolts 31, respectively.

Due to the elastic bodies 25 circulating the bolts 31 while being spaced apart along the pivoting axis A, said elastic support of the vibration generator S on the carrier T is realized that not only allows for a displacement of the pivoting axis A across the pivoting axis A and along the pivoting axis A, but also for a change in the angular position of the pivoting axis A in space or with respect to the carrier T. Due to the elastic properties of both of the bodies 25 this support has the tendency to put the pivoting axis A back into its force-free initial position.

By means of a suitable choice of the elastic properties of the elastic body 25, particularly the material composition of this body 25, resonances of the vibrator device can be specifically displaced, so that they are outside the preferred frequency range of 20-60 Hz in which the vibrator device is preferably operated. Of course, depending on the construction of the vibration generator S, the frequency can be below or above this interval. The amplitude of the vibration of the carrier T or the surface 60 of the carrier T along the z-axis preferably amounts to 0.5 mm to 5 mm, but can also deviate upwardly or downwardly from this range.

In the following features of several advantageous embodiments are described.

In one embodiment it is advantageous that the elastic body (25) consists of a rubber.

In a further embodiment it is advantageous if the vibrator device if the body (25) is formed hollow cylindrical.

In a further vibrator device it is advantageous if the carrier (T) forms a surface (60) that in case of a carrier (T) being arranged as intended extends in a horizontal plane so that a person can occupy said surface (60) of the carrier (T).

In a further embodiment of the vibrator device it is advantageous if the pivoting axis (A) extends parallel with respect to said surface (60) of the carrier (T).

Also, an advantageous vibrator device is provided in case the vibration generator (S)—related to a carrier (T) being arranged as intended—is arranged below the carrier (T) along the vertical direction (z).

According to an aspect of the invention, the vibrator device is characterized by a bottom plate (65) extending along an extension plane, which bottom plate is adapted and provided to be arranged on a plane basis extending along a horizontal plane.

According to an aspect of the invention, the vibrator device is characterized in that the carrier (T) is connected to the bottom plate (65) via at least one spring element (70).

According to an aspect of the invention, the vibrator device is characterized in that the at least one spring element (70) is supported on a supporting element (75) extending perpendicular with respect to the bottom plate and protruding from the bottom plate (65). According to an aspect of the invention, this embodiment is characterized in that the length of the supporting element (75) along its extension direction is chosen such that the vibration generator (S) does not contact the bottom plate or a basis onto which the bottom plate (65) is to be arranged, even in case of full compression of the at least one spring element (70) along the extension direction. It is also advantageous if the vibrator device is characterized in that the carrier (T) is connected to the bottom plate (65) via a plurality of spring elements (70).

According to an aspect of the invention, the vibrator device is characterized in that the vibration generator (S) is adapted to perform a vibration in form of a circular movement in a plane extending perpendicular with respect to the pivoting axis (A).

According to an aspect of the invention, the vibrator device is characterized in that the vibration generator (S) comprises a shaft extending along a rotation axis (A′) for generating the vibration, which shaft is rotatable about said rotation axis (A′), and to which shaft at least one mass element (85, 86) is secured, whose center of mass is spaced apart from the rotation axis (A′) across the rotation axis (A′). According to an aspect of the invention, this vibrator device is characterized in that a further mass element (86) is secured to the shaft (80). It is also advantageous that the vibrator device is characterized in that both mass elements (85, 86) are each secured to a free end section (81, 82) of the shaft (80). It is also advantageous, in case this vibrator device is characterized in that the rotation axis (A′) runs parallel with respect to the pivoting axis (A).

According to an aspect of the invention, the vibrator device is characterized in that the vibration generator (S) comprises freely selectable rotating unbalances and is adapted and provided to force the carrier (T) being arranged as intended to perform vertical vibrations.

1-15. (canceled)

16. A vibrator device for introducing vibrations into a person, comprising:
a carrier which is adapted and provided for contacting a person in order to introduce vibrations into said person,
a vibration generator that is adapted and provided to perform a vibration,
wherein the vibration generator is pivotably supported on the carrier about a pivoting axis in order to transfer vibrations to the carrier,
wherein the vibration generator is elastically supported on the carrier in a plane extending perpendicular to the pivoting axis.

17. The vibrator device according to claim 16, wherein the vibration generator is elastically supported on the carrier in two regions being spaced apart along the pivoting axis in a plane extending perpendicular to the pivoting axis, respectively.

18. The vibrator device according to claim 16, wherein the vibration generator is elastically supported along the pivoting axis on the carrier.

19. The vibrator device according to claim 16, wherein at least one bearing element is provided that is adapted and provided for elastically supporting the vibration generator on the carrier.

20. The vibrator device according to claim 19, wherein the bearing element in case of a vibration generator that is pivoted in a pivoting direction has the tendency to facilitate a pivoting movement of the generation generator in the opposite pivoting direction.

21. The vibrator device according to claim 19, wherein the at least one bearing element comprises an elastic body for elastic support of the vibration generator, which elastic body circulates the pivoting axis in a plane extending perpendicular to the pivoting axis.

22. The vibrator device according to claim 21, wherein the body is enclosed by a first bushing circulating the pivoting axis, via which first bushing the at least one bearing element is connected to the carrier.

23. The vibrator device according to claim 21, wherein the elastic body encloses an inner second bushing circulating the pivoting axis via which second bushing the vibration generator is connected to the at least one bearing element.

24. The vibrator device according to claim 23, wherein a bolt for connecting the vibration generator to the at least one bearing element is provided, wherein the bolt is adapted to reach through the second bushing.

25. The vibrator device according to claim 24, wherein the bolt is secured with a free end section to a flange protruding from the vibration generator.

26. The vibrator device according to claim 24, wherein the bolt aligns with the pivoting axis.

27. The vibrator device according to claim 22, wherein a reception for the first bushing is provided on the carrier which encloses the first bushing in a plane extending perpendicular to the pivoting axis for securing the at least one bearing element to the carrier.

28. The vibrator device according to claim 27, wherein the first bushing is secured in the reception in a rotationally fixed manner.

29. The vibrator device according to claim 19, wherein a further bearing element is provided which is adapted and provided for elastic support of the vibration generator on the carrier, wherein the farther bearing element faces the bearing element along the pivoting axis.

30. The vibrator device according to claim 16, wherein the vibration generator is adapted and provided to perform a vibration in the form of a circular movement and/or in that the vibration generator is elastically supported on the carrier in a way that primarily at least a component of said circular vibration being oriented along the vertical direction is transferred to the carrier.
